(19) United States
(12) Patent Application Publication
(10) Pub. No.: US 2019/0210383 A1
(43) Pub. Date: Jul. 11, 2019

(54) PRINT MEDIA PICK AND FEED

(71) Applicant: Hewlett-Packard Development Company, L.P., Spring, TX (US)

(72) Inventors: Ethan Lee, Vancouver, WA (US); Devin S Uehling, Vancouver, WA (US)

(21) Appl. No.: 16/330,841

(22) PCT Filed: Sep. 8, 2016
(86) PCT No.: PCT/US2016/050757

§ 371 Date: Mar. 6, 2019

(51) Int. Cl. B41J 13/00; B65H 3/06; B65H 5/06; B65H 7/18

(52) U.S. Cl. CPC B41J 13/0045; B65H 7/18; B65H 5/062; B65H 3/0669

(57) ABSTRACT

A system to pick print media from a media tray and feed the print media to a media path includes a pick roller to contact the print media and pick the print media from the media tray, a motor to rotate the pick roller, and a controller to operate the motor to rotate the pick roller in a first mode to pick the print media from the media tray and operate the motor to rotate the pick roller in a second mode different than the first mode to feed the print media to the media path.

### BACKGROUND

A printer may include a media tray to hold a quantity of print media, a print media path to move and/or route print media through the printer, and a pick assembly to pick a sheet of print media from the media tray and feed the sheet to the media path. Improper or ineffective pick and/or feed of print media may result in media damage or jams and/or may result in unintended multi-sheet pick and/or feed of print media.

### BRIEF DESCRIPTION OF THE DRAWINGS

FIG. 1 is a schematic illustration of one example of a portion of a printer.

FIG. 2 is a schematic illustration of one example of a portion of a printer.

FIG. 3 is a schematic illustration of one example of a portion of the printer of FIG. 2.

FIGS. 4A, 4B, 4C, 4D schematically illustrate one example of picking and feeding print media for a printer.

FIG. 5 is a flow diagram illustrating one example of a method of picking and feeding print media for a printer.

### DETAILED DESCRIPTION

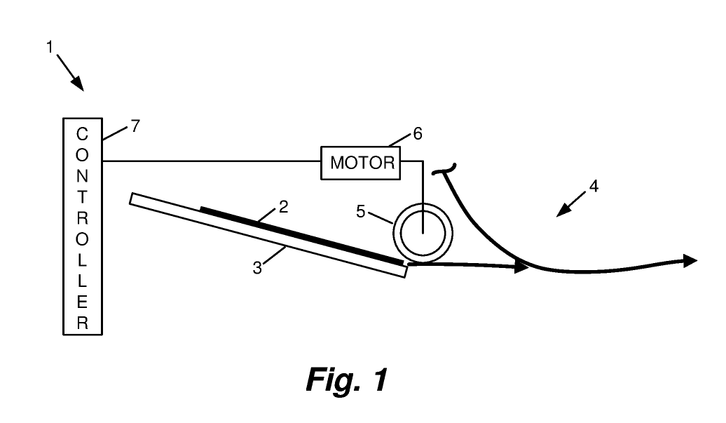

As illustrated in the example of FIG. 1, the present disclosure provides a system 1 to pick print media 2 from a media tray 3 and feed the print media to a media path 4. In one implementation, the system includes a pick roller 5 to contact the print media and pick the print media from the media tray, a motor 6 to rotate the pick roller, and a controller 7 to operate the motor to rotate the pick roller in a first mode to pick the print media from the media tray and operate the motor to rotate the pick roller in a second mode different than the first mode to feed the print media to the media path.

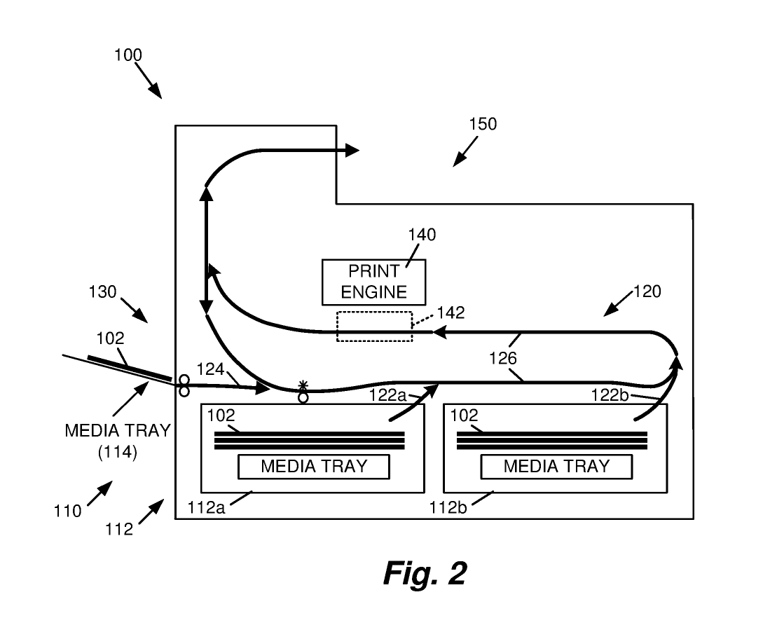

FIG. 2 is a schematic illustration of one example of a portion of a printer 100. In one implementation, printer 100 includes an input tray or trays 110 to supply print media 102, a media path 120 to route print media 102 within printer 100, a pick system or pick assembly 130 to pick print media 102 from input tray or trays 110 and feed print media 102 to media path 120, a print engine 140 to print on print media 102 along media path 120, and an output tray or bin 150 to receive printed print media 102.

Input tray or trays 110 supply a bulk quantity of print media 102 or supply a single quantity of print media 102 to print engine 140 for printing on print media 102 by print engine 140. In one implementation, input trays 110 include a media tray 112 and a multi-purpose media tray 114.

In one implementation, media tray 112 is a tandem media tray set including media trays 112a and 112b. Media trays 112a and 112b are positioned side-by-side or laterally of each other, and each hold a separate quantity of print media 102. Although illustrated and described as a tandem media tray set, media tray 112 may include a single media tray.

In one implementation, multi-purpose media tray 114 is a manual or bypass media tray and receives manual input of print media 102 from externally of printer 100 such that print media 102 is directed to print engine 140 for printing. Print media 102 may include, for example, envelopes, letterhead, checks, fabric, or other print media suited for single or manual input including sheet material, such as paper, card stock, transparencies, Mylar, and the like. Multi-purpose media tray 114 may also support quantities of print media such as multi-sheet stacks of print media for input to printer 100.

Print engine 140 can be a laser print engine, an inkjet print engine, or any other type of print engine. In one implementation, a print area or print zone 142 is defined in which printing on print media 102 by print engine 140 occurs. In one example, printer 100 is implemented as an inkjet printing system, and print engine 140 includes, for example, a printhead assembly.

In one example, output bin 150 is provided at an end of print media path 120 through printer 100. In one example, output bin 150 is excluded such that a media transport path to a separate output device is provided.

Print media path 120 routes print media 102 through printer 100 for printing on print media 102 by print engine 140. More specifically, print media path 120 routes print media 102 from one or more of input trays 110, to and through print zone 142 of print engine 140, and to output bin 150 (or other output device). To achieve the handling and routing of print media 102, print media path 120 may include a variety of guides, rollers, wheels, etc.

In one implementation, print media path 120 includes input path portions 122a and 122b, an input path portion 124, and a print path portion or portions 126. In one example, input path portions 122a and 122b communicate with and receive input of print media 102 from respective media trays 112a and 112b, input path portion 124 communicates with and receives input of print media 102 from multi-purpose media tray 114, and print path portion or portions 126 direct print media 102 through print zone 142 for printing on print media 102 by print engine 140.

As noted above, pick assembly 130 picks print media 102 from input tray or trays 110 and feeds print media 102 to print media path 120. For example, pick assembly 130 picks print media 102 from multi-purpose media tray 114 and feeds print media 102 to input path portion 124 of print media path 120. As such, input path portion 124 directs print media 102 to print path portion 126 of print media path 120.

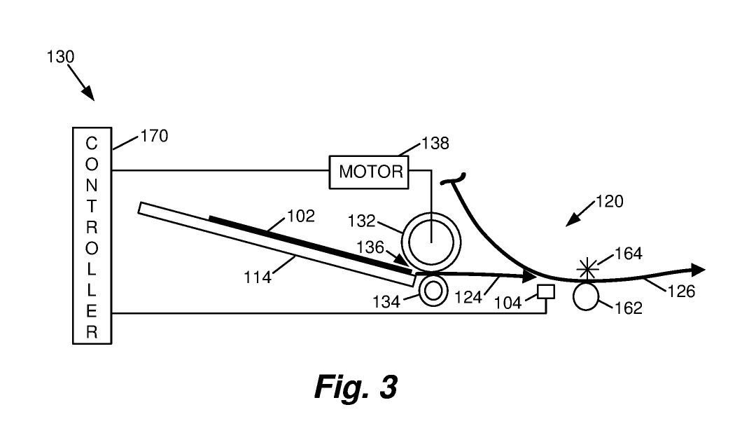

As illustrated in the example of FIG. 3, pick assembly 130 includes a pick tire or pick roller 132 and a separation roller 134 to pick print media 102 from media tray 114 and feed print media 102 to print media path 120 including, for example, input path portion 124 of print media path 120. In one implementation, separation roller 134 is positioned opposite pick roller 132 such that pick roller 132 and separation roller 134 form a nip 136 therebetween. In one implementation, pick roller 132 contacts print media 102 of media tray 114 including, more specifically, a top sheet of print media 102 when multiple sheets of print media 102 are supported by or within media tray 114. As such, separation roller 134 helps to separate print media 102 and prevent multiple sheets of print media 102 from being fed to print media path 120 when multiple sheets of print media 102 are supported by or within media tray 114. Although one pick roller 132 and one separation roller 134 are illustrated and described, pick assembly 130 may include multiple pick rollers 132 and/or multiple separation rollers 134.

In one example, print media path 120 includes a series of opposing rollers and/or wheels, including, for example, a pinch roller 162 and an opposing starwheel 164, to guide and/or route print media 102 along print media path 120 including, for example, print path portion 126 of print media path 120. Although one pinch roller 162 and one starwheel 164 are illustrated and described, multiple pinch rollers 162 and/or multiple starwheels 164, including multiple pinch roller and starwheel pairs, may be provided along print media path 120.

In one implementation, a motor 138 rotates pick roller 132 to pick print media 102 from media tray 114 and feed print media 102 into media path 120, as described below. Motor 138 imparts rotation to pick roller 132 via, for example, a gear, shaft or other coupling.

In one example, a media path sensor 104 senses print media 102 in media path 120. In one implementation, media path sensor 104 provides feedback or input for operating pick assembly 130 and, more specifically, pick roller 132 of pick assembly 130, as described below.

In one example, a controller 170, including a processor and memory, communicates with pick assembly 130 to control operation of pick assembly 130. More specifically, in one implementation, controller 170 communicates with motor 138 and media path sensor 104. As such, controller 170 provides output to motor 138 for operation of pick roller 132 in picking of print media 102 from media tray 114. In addition, controller 170 receives feedback or input from media path sensor 104 regarding a position of print media 102 in media path 120, and provides output to motor 138 for operation of pick roller 132 in feeding of print media 102 to media path 120.

In one embodiment, with input of media path sensor 104, controller 170 determines a position of a leading edge of print media 102 in media path 120. As such, based on the position of the leading edge of print media 102 in media path 120, controller 170 provides output to motor 138 for operation of pick roller 132 in picking of print media 102 from media tray 114 and feeding of print media 102 to media path 120, as described below.

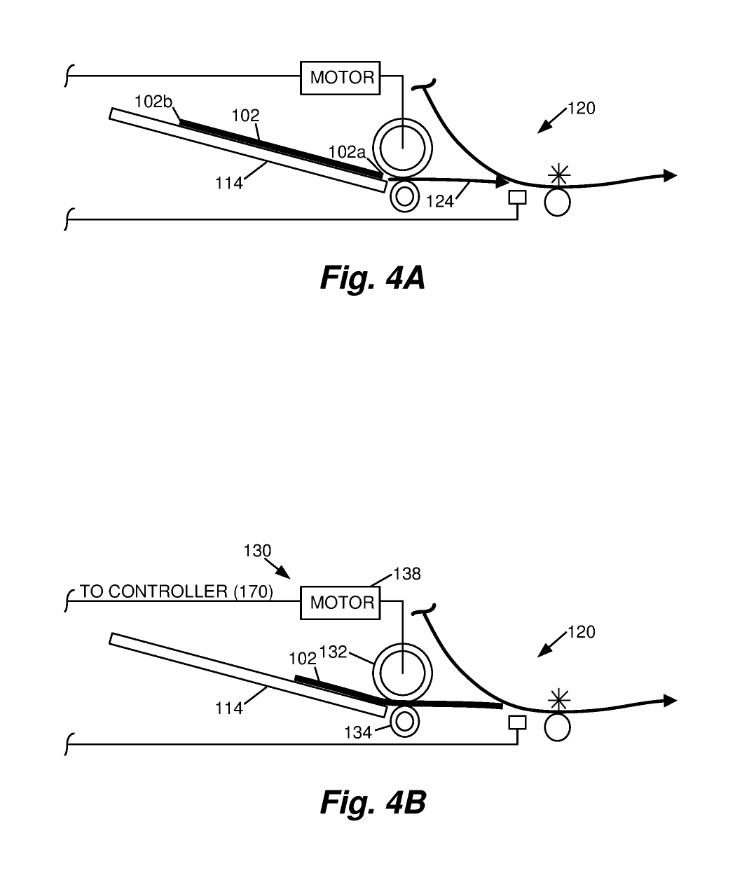

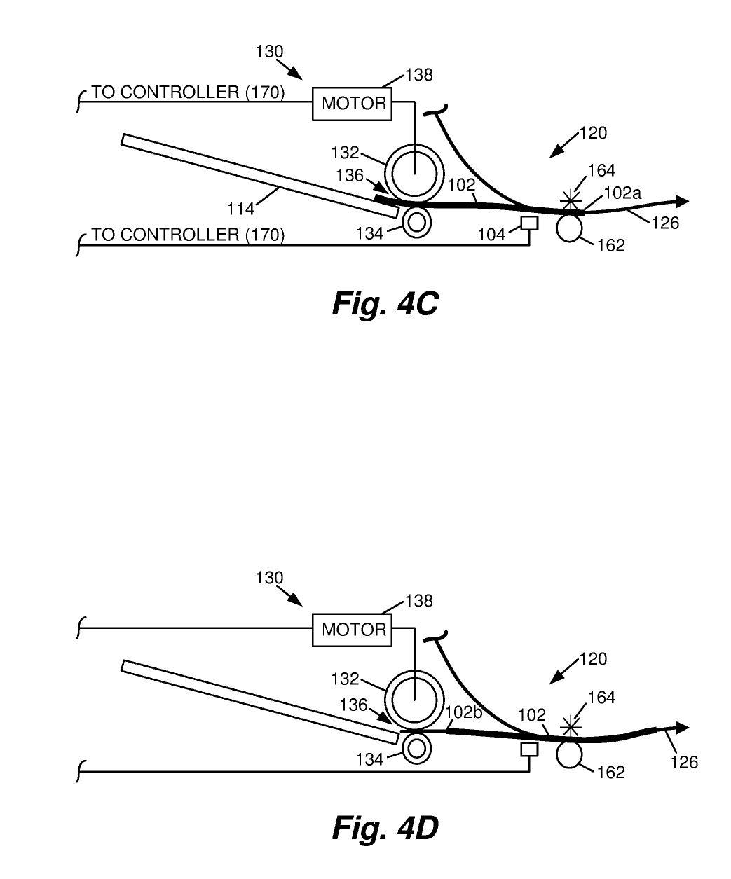

FIGS. 4A, 4B, 4C, 4D schematically illustrate one example of picking arid feeding print media for a printer, such as printer 100 (FIG. 2). As illustrated in the example of FIG. 4A, an input tray, such as media tray 114, holds a quantity of print media 102. As described above, print media 102 may include, for example, envelopes, letterhead, checks, fabric, or other print media suited for single or manual input including sheet material such as paper, card stock, transparencies, Mylar, and the like, and may include multi-sheet stacks of print media. In one example, print media 102 has a leading edge 102a and a trailing edge 102b.

As illustrated in the example of FIG. 4B, pick assembly 130 is operated in a first mode or manner for a first portion of a pick and feed operation to pick print media 102 from media tray 114 and route print media 102 to media path 120 including, for example, input path portion 124 of media path 120 (FIG. 4A). More specifically, pick roller 132 contacts print media 102 and is rotated, counterclockwise in the illustrated example, to pick print media 102 from media tray 114.

In one example, separation roller 134 is separately driven and rotated or subjected to a resistive torque in a direction opposite the direction of media feed (counterclockwise in the illustrated example). In one implementation, a torque limiter (or torque clutch) allows pick roller 132 to overdrive separation roller 134 and rotate separation roller 134 in the direction of media feed (clockwise in the illustrated example). More specifically, in instances, friction between pick roller 132 and separation roller 134, or between pick roller 132 and print media, is enough to overcome the resistive torque and rotate separation roller 134 in the direction of media feed (clockwise in the illustrated example).

For example, when only one sheet of print media is picked and in nip 136, pick roller 132 overcomes the resistive torque of separation roller 134 such that pick roller 132 overdrives separation roller 134 and rotates separation roller 134 in the direction of media feed (clockwise in the illustrated example). More specifically, friction between pick roller 132 and the one sheet of print media is enough to overcome the resistive torque such that the torque limiter allows separation roller 134 to be overdriven and rotated in the direction of media feed (clockwise in the illustrated example). Thus, the one sheet of print media is transported.

However, when multiple sheets of print media are picked and in nip 136, pick roller 132 does not overcome the resistive torque of separation roller 134 such that pick roller 132 does not overdrive separation roller 134 and separation roller 134 does not rotate in the direction of media feed (clockwise in the illustrated example). More specifically, friction between the top sheet of print media and the other sheets of print media below is not high enough to overcome the resistive torque and overdrive separation roller 134. As such, the resistive torque of separation roller 134 rotates separation roller 134 in the direction opposite the direction of media feed (counterclockwise in the illustrated example). Thus, separation roller 134 holds and separates the other sheets of print media, such that only the top sheet of print media is transported.

In one implementation, in picking print media 102 from media tray 114, pick roller 132 is rotated at a substantially constant velocity by motor 138. In one example, the substantially constant velocity of pick roller 132 is maintained using a closed loop control. For example, a speed of motor 138 is monitored and controlled, for example, by controller 170, to maintain a substantially constant velocity of pick roller 132. More specifically, a servo control may be used to control motor 138 and produce a substantially constant velocity of pick roller 132.

As illustrated in the example of FIG. 4C, pick assembly 130 is operated in a second mode or manner for a second portion of a pick and feed operation to feed print media 102 into media path 120 including, for example, print path portion 126 of media path 120. More specifically, in one example, pick roller 132 continues to contact print media 102 and is rotated, counterclockwise in the illustrated example, to feed print media 102 to pinch roller 162 and starwheel 164 of media path 120. In one example, separation roller 134 continues to contact print media 102 and is rotated, clockwise in the illustrated example, to feed print media 102 into media path 120.

In one implementation, in feeding print media 102 into media path 120, pick roller 132 is rotated with a substantially constant torque by motor 138. In one example, the substantially constant torque of pick roller 132 is maintained using an open loop control. For example, a substantially constant current may be applied to motor 138, for example, by controller 170, to rotate pick roller 132 with a substantially constant torque. More specifically, a substantially constant pulse width modulation (PWM) may be used to control motor 138 and produce a substantially constant torque at pick roller 132. In one implementation, the substantially constant torque is defined to overcome, fully, mostly or at least partially, a drag force of nip 136 between pick roller 132 and separation roller 134 (including the resistive torque applied to separation roller 134 in a direction opposite the direction of media feed). Furthermore, in one implementation, the substantially constant torque is defined to avoid picking a next print media from media tray 114, if present.

In one example, rotation of pick roller 132 switches from rotation at a substantially constant velocity to rotation with a substantially constant torque based on a position of print media 102. More specifically, in one implementation, control of motor 138 switches from closed loop control for the substantially constant velocity to open loop control for the substantially constant torque when print media 102 including, more specifically, leading edge 102a of print media 102 is at (or beyond) pinch roller 162 of media path 120. In one example, leading edge 102a of print media 102 is sensed by media path sensor 104 and provided as input to controller 170.

As illustrated in the example of FIG. 4D, pinch roller 162 and starwheel 164 continue to feed print media 102 into media path 120 including, for example, print path portion 126 of media path 120. More specially, in one example, pinch roller 162 and starwheel 164 contact print media 102 and pinch roller 162 is rotated, clockwise in the illustrated example, to feed and guide print media 102 into print path portion 126 of media path 120. As such, print media 102 is pulled from pick roller 132 and separation roller 134 and fed into print path portion 126 of media path 120.

In one implementation, after print media 102 leaves pick roller 132, operation of pick assembly 130 is paused or discontinued. More specifically, in one example, after trailing edge 102b of print media 102 leaves nip 136 between pick roller 132 and separation roller 134, pick roller 132 stops rotating and is idle.

More specifically, in one implementation, in operating pick assembly 130 in the first mode or manner, voltage is applied to motor 138 to rotate pick roller 132 at a substantially constant velocity, as described above. In addition, in one implementation, in operating pick assembly 130 in the second mode or manner, only enough voltage is applied to motor 138 to overcome the drag force of nip 136 between pick roller 132 and separation roller 134 (including the resistive torque applied to separation roller 134 in a direction opposite the direction of media feed), as described above. Thus, with no print media in nip 136, pick roller 132 is in a balanced state or equilibrium state with no velocity such that pick roller 132 is idle. However, as print media is pulled from nip 136, pick roller 132 rotates with a substantially constant torque.

In one example, with print media 102 fully within media path 120, operation of motor 138 returns to closed loop control. As such, operation of pick assembly 130, as described above, may be repeated for a next or another print media 102.

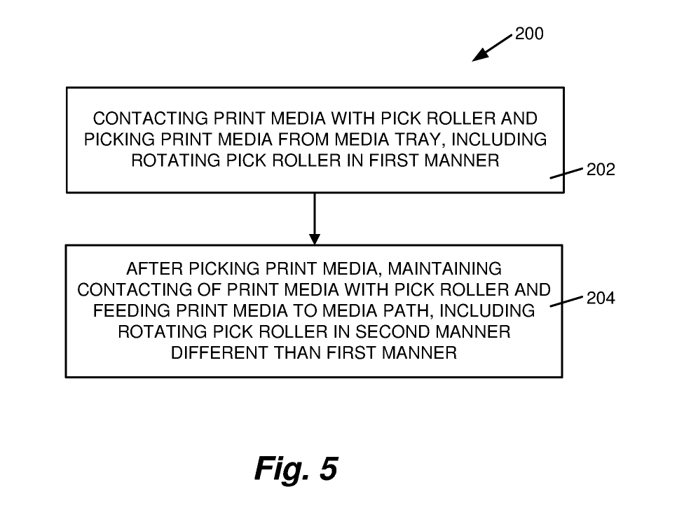

FIG. 5 is a flow diagram illustrating one example of a method 200 of picking print media from a media tray, such as print media 102 from media tray 114, and feeding the print media to a media path, such as media path 120, as illustrated, for example, in FIGS. 4A-4D.

At 202, method 200 includes contacting the print media with a pick roller, such as pick roller 132, and picking the print media from the media tray, such as print media 102 from media tray 114, as illustrated, for example, in FIG. 4B. At 202, contacting the print media with the pick roller and picking the print media from the media tray includes rotating the pick roller in a first manner. In one implementation, rotating the pick roller in a first manner, for example, at 202, includes rotating the pick roller at a substantially constant velocity.

At 204, after picking the print media, method 200 includes maintaining the contacting of the print media with the pick roller and feeding the print media to the media path, such as pick roller 132 contacting print media 102 and feeding print media 102 to media path 120, as illustrated, for example, in FIG. 4C. At 204, maintaining the contacting of the print media with the pick roller and feeding the print media to the media path includes rotating the pick roller in a second manner different than the first manner. In one implementation, rotating the pick roller in a second manner different than the first manner, for example, at 204, includes rotating the pick roller with a substantially constant torque.

In one example, rotating the pick roller in a second manner different than the first manner, for example, at 204, includes switching from the first manner to the second manner when a leading edge of the print media is at a pinch roller of the media path, such as leading edge 102a of print media 102 at pinch roller 162 of media path 120, as illustrated, for example, in FIG. 4C.

Operating a pick assembly, such as pick assembly 130, as illustrated and described herein, results in handling or moving print media in a first manner for a first portion of a pick and feed operation and handling or moving print media in a second manner for a second portion of a pick and feed operation. More specifically, rotating pick roller 132 in a first mode or manner with a substantially constant velocity facilitates picking of print media from an input tray, such as media tray 114, and feeding the print media into a media path, such as media path 120, and rotating pick roller 132 in a second mode or manner with a substantially constant torque facilitates continued feeding of the print media into the media path. As such, picking print media from an input tray and feeding print media into a media path, as illustrated and described herein, provides for picking and feeding of print media without knowing a location or position of a trailing edge of the print media. In addition, by picking and feeding print media, as illustrated and described herein, media damage and/or media jams, as well as unintended multi-sheet pick and/or feed of print media may be minimized or avoided. For example, if a location or position of a trailing edge of a print media is unknown, rotating pick roller 132 for a length longer than a length of the print media may result in additional sheets of print media being picked and fed. Rotating pick roller 132 for a length shorter than a length of the print media, however, may tear the print media and/or result in a media jam, as rollers and/or wheels of the media path, such as pinch roller 162 and starwheel 164, may not be able to pull the print media out of the nip of pick roller 132 and separation roller 134 due to the drag force created by the nip. Thus, rotating pick roller 132 in a second mode or manner with a substantially constant torque, as illustrated and described herein, allows or makes it easier for rollers and/or wheels of the media path, such as pinch roller 162 and starwheel 164, to “pull” the print media out of the nip of pick roller 132 and separation roller 134 for continued feeding of the print media into the media path without knowing a location or position of a trailing edge of the print media and without damaging the print media and/or creating a media jam. Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein.

1. A system to pick print media from a media tray and feed the print media to a media path, comprising:
a pick roller to contact the print media and pick the print media from the media tray;
a motor to rotate the pick roller; and
a controller to operate the motor to rotate the pick roller in a first mode to pick the print media from the media tray and operate the motor to rotate the pick roller in a second mode different than the first mode to feed the print media to the media path.

2. The system of claim 1, wherein the first mode comprises a closed loop control, and the second mode comprises an open loop control.

3. The system of claim 1, wherein the first mode is to rotate the pick roller at a substantially constant velocity.

4. The system of claim 1, wherein the second mode is to rotate the pick roller with a substantially constant torque.

5. The system of claim 4, further comprising:
a separation roller opposite the pick roller, wherein the pick roller and the separation roller form a nip therebetween,
wherein the substantially constant torque of the second mode is to overcome a drag force of the nip.

6. The system of claim 4, wherein the substantially constant torque of the second mode is to avoid picking a next print media from the media tray.

7. The system of claim 1, wherein the print media has a leading edge and a trailing edge, and further comprising:
a pinch roller to contact the print media and route the print media in the media path,
wherein the controller is to switch from the first mode to the second mode when the leading edge of the print media is at the pinch roller.

8. A printer, comprising:
a media tray to hold a quantity of print media; and
a pick assembly to pick a sheet of the print media from the media tray and feed the sheet of the print media to a media path,
wherein a pick roller of the pick assembly is to rotate with a substantially constant velocity to pick the sheet of the print media from the media tray and rotate with a substantially constant torque to feed the sheet of the print media to the media path.

9. The printer of claim 8, wherein rotation of the pick roller is to switch from the substantially constant velocity to the substantially constant torque when a leading edge of the sheet of the print media is at a pinch roller of the media path.

10. The printer of claim 8, wherein the substantially constant torque is to overcome a drag force of the pick assembly.

11. The printer of claim 8, wherein the substantially constant torque is to avoid pick of a next sheet of the print media from the media tray.

12. A method of picking and feeding print media, comprising:
contacting print media with a pick roller and picking the print media from a media tray, including rotating the pick roller in a first manner; and
after picking the print media, maintaining the contacting of the print media with the pick roller and feeding the print media to a media path, including rotating the pick roller in a second manner different than the first manner.

13. The method of claim 12, wherein rotating the pick roller in a first manner includes rotating the pick roller at a substantially constant velocity.

14. The method of claim 12, wherein rotating the pick roller in a second manner includes rotating the pick roller with a substantially constant torque.

15. The method of claim 12, wherein rotating the pick roller in a second manner includes switching from the first manner to the second manner when a leading edge of the print media is at a pinch roller of the media path.
